(19) United States
(12) Patent Application Publication
(10) Pub. No.: US 2026/0120719 A1
(43) Pub. Date: Apr. 30, 2026

(54) VIDEO PROCESSING METHOD, DEVICE AND MEDIUM

(71) Applicant: Beijing Zitiao Network Technology Co., Ltd., Beijing (CN)

(72) Inventor: Lushuang CHEN, Beijing (CN)

(21) Appl. No.: 19/374,892

(22) Filed: Oct. 30, 2025

(30) Foreign Application Priority Data
Oct. 31, 2024 (CN) 202411546077.9

(51) Int. Cl. G11B 27/031; G06F 40/205; G06F 40/284; G06F 40/30; G06T 11/60

(52) U.S. Cl. CPC G11B 27/031; G06F 40/205; G06F 40/284; G06F 40/30; G06T 11/60

(57) ABSTRACT

A video processing method, apparatus, device, and medium are provided. The video processing method includes: obtaining a target subtitle corresponding to a first video; performing text parsing on the target subtitle, and determining a target icon corresponding to the target subtitle based on a text parsing result of the target subtitle; obtaining video associated information corresponding to the target subtitle in the first video, and determining a recommended display mode of the target icon based on the video associated information, the video associated information including at least one of video image information or audio information; and generating a target video based on the first video and the recommended display mode of the target icon, the target video is a video in which the target subtitle and the target icon are displayed on a video image of the first video.

### CROSS-REFERENCE TO RELATED APPLICATION

The present disclosure claims priority of the Chinese Patent Application No. 202411546077.9 filed on Oct. 31, 2024, the present disclosure of which is incorporated herein by reference in its entirety as part of the present application.

### TECHNICAL FIELD

The present disclosure relates to the field of computer technology, and more particularly to a video processing method, apparatus, device, and medium.

### BACKGROUND

Nowadays, more and more ordinary users, professional edit engineers and other people need to use multimedia edit software to edit the captured videos to enrich the visual presentation effect. For example, in order to facilitate video viewers to clearly know the content of audio and video, most video edit users will add subtitles to videos, and some multimedia edit software has also provided users with functions such as audio to subtitles. However, through research, the inventors have found that the video provided through subtitles has limited information expression ability, and is lack of interest, which needs to be further improved.

### SUMMARY

In order to solve the above-described technical problems or at least partially solve the above-described technical problems, the present disclosure provides a video processing method, apparatus, device, and medium.

An embodiment of the present disclosure provides a video processing method, which includes: obtaining a target subtitle corresponding to a first video; performing text parsing on the target subtitle, and determining a target icon corresponding to the target subtitle based on a text parsing result of the target subtitle; obtaining video associated information corresponding to the target subtitle in the first video, and determining a recommended display mode of the target icon based on the video associated information, the video associated information including at least one of video image information or audio information; and generating a target video based on the first video and the recommended display mode of the target icon, the target video is a video in which the target subtitle and the target icon are displayed on a video image of the first video.

Optionally, the text parsing result of the target subtitle includes a token result of the target subtitle and target information corresponding to the token result, and the target information includes at least one selected from a group consisting of a word position, a word class, a word occurrence frequency, and an associated word; the determining a target icon corresponding to the target subtitle based on a text parsing result of the target subtitle includes: determining a candidate icon corresponding to the target subtitle based on the token result of the target subtitle; and determining a target icon corresponding to the target subtitle from the candidate icon based on the target information corresponding to the token result.

Optionally, the determining a candidate icon corresponding to the target subtitle based on the token result of the target subtitle includes: determining, using a semantic matching model, an icon having a mapping relationship with a target word in the target subtitle based on the token result of the target subtitle and a preset icon resource library; and determining the candidate icon corresponding to the target subtitle based on the icon corresponding to the target word.

Optionally, the determining a target icon corresponding to the target subtitle from the candidate icon based on the target information corresponding to the token result includes: obtaining first reference information, the first reference information including at least one selected from a group consisting of: accent information of audio corresponding to the target subtitle, feature analysis information of the target subtitle, or number constraint information of the target icon; and determining the target icon corresponding to the target subtitle from the candidate icon based on the first reference information and the target information corresponding to the token result.

Optionally, the obtaining video associated information corresponding to the target subtitle in the first video includes: obtaining motion information and target object information of the video image corresponding to the target subtitle in the first video, and obtaining the video image information corresponding to the target subtitle based on the motion information and the target object information; and/or, obtaining key point information of audio corresponding to the target subtitle in the first video, and obtaining the audio information corresponding to the target subtitle based on the key point information.

Optionally, the determining a recommended display mode of the target icon based on the video associated information includes: determining a recommended display position and a recommended display animation of the target icon based on the video image information; determining a recommended display time for the target icon based on the audio information; and obtaining the recommended display mode of the target icon based on the recommended display position, the recommended display animation, and the recommended display time.

Optionally, the generating a target video based on the first video and the recommended display mode of the target icon includes: obtaining second reference information, the second reference information including at least one selected from a group consisting of: size information of the target icon, occurrence timing information of the target icon, or animation style information of the target icon; determining a target display mode of the target icon based on the second reference information and the recommended display mode of the target icon; and generating a target video based on the first video and the target display mode.

An embodiment of the present disclosure further provides a video processing apparatus, which includes: a subtitle obtaining module, configured to obtain a target subtitle corresponding to a first video; an icon determination module, configured to perform text parsing on the target subtitle, and determine a target icon corresponding to the target subtitle based on a text parsing result of the target subtitle; a display information determination module, configured to obtain video associated information corresponding to the target subtitle in the first video, and determine a recommended display mode of the target icon based on the video associated information, the video associated information including at least one of video image information or audio information; a video generation module, configured to generate a target video based on the first video and a recommended display mode of the target icon, the target video is a video in which the target subtitle and the target icon are displayed on a video image of the first video.

An embodiment of the present disclosure further provides an electronic device, the electronic device includes: a processor; a memory for storing instructions executable by the processor; the processor is configured to read the executable instructions from the memory and execute the instructions to implement the video processing method provided by the embodiment of the present disclosure.

An embodiment of the present disclosure further provides a non-transitory computer-readable storage medium, the non-transitory computer-readable storage medium stores a computer program for performing the video processing method provided by the embodiment of the present disclosure.

An embodiment of the present disclosure further provides a computer program product, which includes a computer program, the computer program, when executed by a processor, implements the video processing method provided by the embodiment of the present disclosure.

According to the technical solution provided by the embodiment of the present disclosure, the target subtitle corresponding to the first video can be obtained, the target subtitle can be text parsed, the target icon corresponding to the target subtitle can be determined based on a text parsing result of the target subtitle, and the video associated information (at least one of video image information or audio information) corresponding to the target subtitle in the first video can be further obtained to determine a recommended display mode of the target icon, thereby generating a target video in which the target subtitle and the target icon are displayed on a video image of the first video. The above method can parse the subtitle, adaptively add a suitable target icon in combination with the at least one of video image information or audio information associated with the subtitle, further improve the information expression ability through the icon on the basis of the subtitle, and also increase the interest and appeal of the video, so as to better improve the video viewing experience of the user.

It should be understood that what is described in this section is not intended to identify key or important features of embodiments of the present disclosure, nor is it intended to limit the scope of the present disclosure. Other features of the present disclosure will be readily understood by the following description.

### BRIEF DESCRIPTION OF DRAWINGS

The accompanying drawings herein, which are incorporated into the specification and constitute a part of the specification, illustrate embodiments consistent with the present disclosure and, together with the specification, serve to explain the principles of the present disclosure.

In order to more clearly explain the technical solutions in the embodiments of the present disclosure or in the existing art, the drawings that need to be used in the description of the embodiments or in the existing art will be briefly introduced below, and it is obvious that other drawings can be obtained from these drawings without making any creative labor for those skilled in the art.

FIG. 1 is a schematic flow diagram of a video processing method provided by an embodiment of the present disclosure.

FIG. 2 is a schematic diagram of a video image to which a target icon is added provided by an embodiment of the present disclosure.

FIG. 3 is a schematic diagram of a generation flow of a recommended display mode provided by an embodiment of the present disclosure;

FIG. 4 is a schematic diagram of a video generation flow provided by an embodiment of the present disclosure.

FIG. 5 is a schematic structural diagram of a video processing apparatus provided by an embodiment of the present disclosure.

FIG. 6 is a schematic structural diagram of an electronic device provided by an embodiment of the present disclosure.

### DETAILED DESCRIPTION

In order to enable a clearer understanding of the above-described objects, features, and advantages of the present disclosure, aspects of the present disclosure will be further described below. It should be noted that the embodiments of the present disclosure and the features in the embodiments may be combined with each other without conflict.

Numerous specific details are set forth in the following description to facilitate a full understanding of the present disclosure, but the present disclosure may be implemented in other ways than those described herein. It is obvious that the embodiments in the specification are only some embodiments of the present disclosure, but not all embodiments.

FIG. 1 is a schematic flow diagram of a video processing method provided by an embodiment of the present disclosure, and the method can be executed by a video processing apparatus, the apparatus can be implemented by software and/or hardware, and can generally be integrated into an electronic device. As shown in FIG. 1, the method mainly includes the following steps S102 to S108.

In step S102, obtaining a target subtitle corresponding to a first video.

In the embodiment of the present disclosure, the content of the first video is not limited, and the target subtitle corresponding to the first video may be a subtitle included in the first video itself, or may be a subtitle obtained by performing content recognition on audio of the first video. In some embodiments, each subtitle that appears in the first video may be a target subtitle. In other embodiments, the target subtitle may be a subtitle specified by the user or a subtitle conforming to a preset feature, for example, the preset feature may be: the number of words of the subtitle being greater than the preset number of words, the video image where the subtitle is located being not a transition image or not an image with a strong motion amplitude, and the like. Specifically, the obtaining condition of the target subtitle can be flexibly set according to the needs, and there is no restriction here.

Step S104, performing text parsing on the target subtitle, and determining a target icon corresponding to the target subtitle based on a text parsing result of the target subtitle.

Exemplarily, the text parsing result of the target subtitle includes a token result of the target subtitle and target information corresponding to the token result. That is, the embodiment of the present disclosure may perform token processing on the target subtitle, perform parsing based on the token result, and obtain target information corresponding to the token result, and the token result may be used to indicate each word in the target subtitle, and may further include a word group having a dependency relationship (that is, associated words). In addition, when parsing based on the token result, it is possible to determine a word class (such as a noun, verb, adjective, adverb, etc.) in the token result, whether it is a stop word (such as a common word that frequently occurs but usually does not carry an important meaning), whether it is a negative word (which can be used to identify the negative meaning contained in the text, which is more convenient to accurately extract text information and analyze the meaning features of the text), etc., and it is also possible to further detect a position, occurrence frequency and associated words of each word in the token result. The target information may include one or more information such as word position, word class, word occurrence frequency, and associated words. In addition, the text parsing may further include feature analysis, and the text parsing result may further include feature analysis information of the target subtitle. For example, by analyzing the content of the barrage text, using natural language processing technology to infer and identify the specified feature information carried by the barrage text, and obtaining the feature analysis information of the target subtitle. The specified feature information may be a feature affecting icon selection, such as a meaning feature, or the like. In other words, the specified feature information may be used as a reference factor for icon selection, and the specified feature to be analyzed can be flexibly set, and is not limited here. In practical applications, keyboard distance, editing distance, language model and contextual information can also be used to automatically detect and correct spelling errors in the text when performing text parsing on the target subtitle. For the text of specific languages such as English, it can also take into account its grammatical and lexical context, lexical rules and morphological information, and restore words to their basic form or dictionary form. For example, words represented by past tense and other tense representations are uniformly converted into present tense representations, thus ensuring semantic conformance, helping to reduce vocabulary complexity and improving the accuracy of text processing. All of the above are examples, and the embodiment of the present disclosure does not limit the text parsing method of subtitles. Through the above text parsing, it is helpful to more reasonably and comprehensively select the target icon based on the text parsing result of the target subtitle.

The icons referred to in embodiments of the present disclosure include, but are not limited to, an Emoji (expression symbol) icon, and may be other icons capable of transmitting information or expressing a specific meaning, and are not limited herein. Based on the text parsing result of the target subtitle, the target icon matching the target subtitle can be found from a plurality of existing icons. The target icon corresponding to the target subtitle may include an icon corresponding to a keyword in the target subtitle, or may include an icon corresponding to a semantic meaning of the target subtitle. It should be noted that the number of target icons corresponding to the target subtitle may be one or more, or there may be no target icon. It can be understood that a video usually has a plurality of subtitles, and the keywords or semantics in different subtitles may be different, and the corresponding target icons may also be different, and some sentences may not have appropriate icons because they contain many words without important meaning such as stop words or their own semantics.

Step S106: obtaining video associated information corresponding to the target subtitle in the first video, and determining a recommended display mode of the target icon based on the video associated information; the video associated information including at least one of video image information or audio information.

The video image information corresponding to the target subtitle is the video image matched with the audio corresponding to the target subtitle in the first video, in other words, the video associated information corresponding to the target subtitle and the target subtitle have the same appearance time in the first video. In the embodiment of the present disclosure, not only the target subtitle, but also the video associated information of the target subtitle can be analyzed to determine a recommended display mode of the target icon, and the recommended display mode includes but is not limited to a recommended display position, a recommended display time, a recommended display animation, and the like of the target icon, so as to ensure that the target icon can be more reasonably displayed on the video image, or that the target icon can be displayed rhythmically with audio corresponding to the target subtitle. By analyzing the video associated information, the recommended display mode of the target icon can be more reasonably determined to ensure the display effect of the target icon.

Step S108: generating a target video based on the first video and the recommended display mode of the target icon; the target video being a video in which the target subtitle and the target icon are displayed on a video image of the first video.

Based on the recommended display mode of the target icon, rendering the target icon on the video image of the first video corresponding to the target subtitle can be performed, and the target video based on the video image after rendering is obtained. In addition, it should be noted that in response to the first video itself having the target subtitle, it is not necessary to render the target subtitle when rendering the target icon, and in response to the first video itself not having the target subtitle and the target subtitle being obtained by performing speech recognition on the first video, it is necessary to render the target subtitle when rendering the target icon. No matter what method, the finally presented target video will present both the target subtitle and the target icon on the basis of the video image of the first video, and has strong information expression ability.

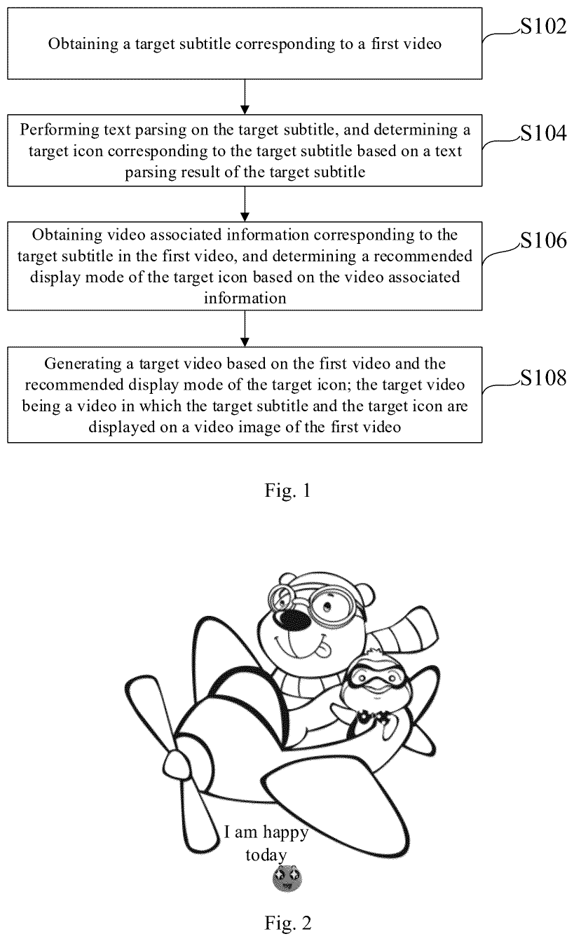

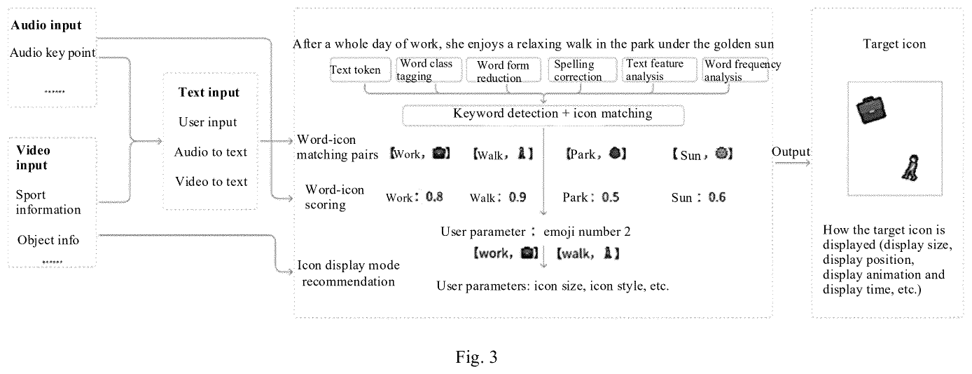

For convenience of understanding, a diagram of a video image in which a target icon is added as shown in FIG. 2 can be referred to, and a video image in a target video is schematically illustrated, on which not only the target subtitle “I am happy today” is presented, but also the corresponding Emoji icon for expressing the meaning of happiness is added. In this way, the meaning of happiness can be further strengthened by the icon on the basis of the target subtitle, and the icon can transmit information more directly and interestingly than the subtitle.

To sum up, the above method can parse the subtitle, adaptively add an appropriate target icon in combination with the at least one of video image information or audio information associated with the subtitle, further improve the information expression ability through the icon on the basis of the subtitle, and also increase the interest and appeal of the video, so as to better improve the user's video viewing experience.

In some embodiments, the text parsing result of the target subtitle includes the token result of the target subtitle and the target information corresponding to the token result, and the target information includes at least one selected from a group consisting of a word position, a word class, a word occurrence frequency, and an associated word. In addition, the target information can also be used to indicate special words such as a negative word and a stop word in the token result or to indicate a keyword having a specified feature in the token result. Exemplarily, the step of determining the target icon corresponding to the target subtitle based on the text parsing result of the target subtitle may be executed with reference to the following steps A and B.

Step A: determining a candidate icon corresponding to the target subtitle based on the token result of the target subtitle. In some embodiments, a corresponding icon may be obtained based on each word obtained by token processing in the target subtitle, and the obtained icon may be used as a candidate icon corresponding to the target subtitle. In other embodiments, based on the token result of the target subtitle, a target word conforming to a preset condition may be selected from the words obtained by token processing in the target subtitle, and an icon corresponding to the target word may be used as a candidate icon corresponding to the target subtitle, for example, the candidate icon corresponding to the target subtitle may be determined based on the token result of the target subtitle and the target information corresponding to the token result.

In some specific embodiments, step A may be performed with reference to steps A1 to A2 as follows:
Step A1, determining, using a semantic matching model, an icon having a mapping relationship with a target word in the target subtitle based on the token result of the target subtitle and a preset icon resource library. In a specific implementation, label features can be constructed and extracted on a plurality of existing icons, the plurality of icons and icon information such as semantic feature and expression meaning of respective icons can be stored in an icon resource library in an association way, and an icon in which the target word in the target subtitle has a mapping relationship is determined by using a semantic matching model based on the token result or based on the token result and target information corresponding to the token result. The semantic matching model is a neural network model obtained by pre-training, such as language model, etc. For example, a training sample pair composed of a word sample and a corresponding icon can be obtained, and the neural network model can be trained based on the training sample pair, so as to obtain the semantic matching model, which has the ability to output a matching icon for the input token result.

In some embodiments, the target word may be each word in the target subtitle. In other embodiments, the target word may be a keyword having a specified feature in the target subtitle. The specified feature includes at least one selected from a group consisting of: a specified position (such as before, middle, after, etc.) of a word position in the target subtitle, a specified word class (such as noun, verb, adjective, etc.), an occurrence frequency of the word being in a preset frequency interval (such as repeated twice or more in the target subtitle, or appearing in a subtitle before the target subtitle, etc.), an accent word, a word in pronunciation duration over preset duration. In a case where the target word is a keyword having a specified feature, step A1 may specifically be to determine an icon having a mapping relationship with a target word of the target subtitle by using a semantic matching model based on the token result of the target subtitle, target information corresponding to the token result, and a preset icon resource library.

In step A2, determining a candidate icon corresponding to the target subtitle based on the icon corresponding to the target word. In some embodiments, in response to the target word being a keyword having a specified feature, the icon corresponding to the target word may be directly used as a candidate icon corresponding to the target subtitle. In other embodiments, in response to the target word being all words having corresponding icons in the target subtitle, the keyword having a specified feature may be further selected from the target word based on target information corresponding to the token result, and the icon corresponding to the keyword may be used as the candidate icon corresponding to the target subtitle. For example, the target subtitle is “After a whole day of work, she enjoys a relaxing walk in the park under the golden sun”. Although there are many tokens after token processing, and many tokens have corresponding icons, the candidate icons corresponding to the target subtitle preliminarily selected include: a briefcase icon corresponding to “work”, a walking icon corresponding to “walking”, a tree icon corresponding to “park”, and a sun icon corresponding to “sun”.

Step B: determining a target icon corresponding to the target subtitle from the candidate icon based on the target information corresponding to the token result. In some embodiments, the scoring dimension of each candidate icon may be determined based on the target information corresponding to the token result, the weight and score corresponding to each scoring dimension may be obtained, the comprehensive score of each candidate icon may be obtained by a weighted summation method, the comprehensive scores of respective candidate icons may be sorted in a descending order based on the comprehensive score of each candidate icon, and then the top N target icons may be selected according to the sorting result. N can be a preset default value, a value set by the user, or it can be determined based on the total number of candidate icons and a preset ratio, and there is no restriction here. In some specific embodiments, step B may be performed with reference to steps B1 to B2 as follows.

Step B1: obtaining first reference information; the first reference information including at least one selected from a group consisting of accent information of audio corresponding to the target subtitle (which may be referred to as an audio accent point), feature analysis information of the target subtitle, or number constraint information of the target icon.

In practical applications, the audio accent point corresponding to the target subtitle can be determined by a method such as accent recognition, and the audio accent point corresponding to the target subtitle can be obtained, and the feature analysis on the target subtitle can be performed. Specifically, the natural language processing technology can be used to infer and recognize the designated feature information carried by the text, and the feature analysis information of the target subtitle can be obtained. Both the above-described accent information and the feature analysis information can be performed by a background algorithm. The number constraint information of the target icon may be background preset value or may be obtained by user setting information, and is not limited here, and the number constraint information may be used to indicate a specific number or number range of the target icons corresponding to the target subtitle. In practical applications, the contents included in the first reference information can be flexibly selected according to requirements, and other reference information can also be added, which is not limited here.

Step B2, determining the target icon corresponding to the target subtitle from the candidate icon based on the first reference information and target information corresponding to the token result. For example, the target icon may be an icon with a specified word class and a word frequency higher than preset threshold and/or the word corresponding to the target icon is an audio accent point in the target subtitle; and the positions of the words corresponding to the plurality of target icons are not adjacent positions, and the target icon is also matched with the feature analysis information of the target subtitle. In practical application, the scoring dimension corresponding to the candidate icon may be determined based on the target information corresponding to the token result, the information other than the number constraint information of the target icon in the first reference information, a word corresponding to the candidate icon, and the weight corresponding to the scoring dimension and the score of each candidate icon in the scoring dimension may be obtained, the comprehensive score of each candidate icon may be obtained based on the score and weight corresponding to each candidate icon in each scoring dimension, and then the target icon corresponding to the target subtitle may be determined from the candidate icons based on the comprehensive score of each candidate icon and the number constraint information of the target icon. In some embodiments, the weight of the scoring dimension related to the occurrence frequency of the word is affected by the word class, for example, for words with pronouns, adjectives, adverbs, common words, etc., even though the occurrence frequency is high, the weight is low, and the way of adjusting the weight can be understood as performing a frequency reduction correction process for such words to reduce the positive influence of the frequency of such words on the score. For verbs, nouns and other words, the higher the frequency, the higher the corresponding weight and the higher the corresponding score. Through the above method, one or more most suitable target icons can be reasonably selected, and the repetition degree of the target icons can be restricted, thereby avoiding the same target icon from appearing repeatedly within sentences and between sentences, thereby improving the richness and diversity of icon display. In addition, the target information corresponding to the token result also includes the word position, so when selecting the target icon from the candidate icons, the icon corresponding to the adjacent word can also be excluded, that is, the adjacent word trigger suppression process can be performed to avoid the appearance of a plurality of icons in succession and influence the perception.

An embodiment of the present disclosure provides an exemplary implementation of obtaining video associated information corresponding to a target subtitle in a first video, and can be implemented with reference to the following (1) and/or (2).

(1) obtaining motion information and target object information in an video image corresponding to the target subtitle in the first video, and obtaining video image information based on the motion information and the target object information. In practical applications, visual feature detection can be performed on the first video, for example, the motion degree of the video image in the first video is detected according to the motion light of the first video, and basic image features such as static, dynamic, and transition are given. Through the above method, the motion information, specifically, motion degree information and the like, of the video image corresponding to the target subtitle in the first video can be obtained. In addition, it is also possible to obtain target object information in the video image by using a target object detection algorithm, key point detection algorithm, or the like, for example, the target object information includes at least one selected from a group consisting of a position of the target object, a key point of the target object, a size of the target object, and action information of the target object. In the embodiment of the present disclosure, the motion information and target object information corresponding to the target subtitle in the first video may be used together as video image information corresponding to the target subtitle.

(2) obtaining key point information of audio corresponding to the target subtitle in the first video, and obtaining audio information corresponding to the target subtitle based on the key point information. Key point information of audio includes but is not limited to highlight such as an audio stuck point, audio accent point and the like. In practical applications, the audio corresponding to the first video can be processed by beat detection, accent recognition, music category detection, etc., so as to obtain an audio-related feature and obtain key point information of the audio corresponding to the first video.

In the case where the video associated information includes video image information and audio information, determining the recommended display mode of the target icon based on the video associated information can be executed by referring to the following steps a to c.

Step a, determining a recommended display position and a recommended display animation of the target icon based on the video image information. It can be understood that the video image information may include motion information of the video image and target object information of video image, and based on motion information, it is possible to determine whether the target icon should be presented in the video image and the presentation animation style of the presented target icon. For example, the target icon may not be clearly presented for the video image with transition and large motion amplitude, and the display position can be set to be empty, while the video image with relatively small motion amplitude is more suitable for presenting the target icon. In addition, the recommended display position of the target icon can be determined based on target object information, for example, the position of the target icon does not coincide with the position of target object, so as to avoid the target icon blocking target object. In a specific implementation, the target icon can be set in the background area of target object, and further the target icon can be arranged around target object. In addition, It is also possible to comprehensively determine the recommended display position of the target icon by combining the subtitle position of the target subtitle in the video image and the video image information, such as setting the relative position between the target icon and the target subtitle, such as horizontal alignment, vertical alignment, alignment between the icon and the text center, overlapping the icon at the bottom of the text, and random movement of the icon in the subtitle box. Further, the recommended display animation of the target icon may be determined based on the motion degree of video image and/or the action of target object of video image, and the effect of target icon dynamic following can be achieved. The recommended display animation can be an animation such as uniform rotation, random rotation, left-right movement, clockwise rotating by a specified angle when entering and leaving, scale/scaling, shaking, etc., which are merely examples and should not be regarded as limitations.

Step b, determining the recommended display time of the target icon based on the audio information. For example, the recommended display time of the target icon may be determined based on key point time such as an audio stuck point or an audio accent point in the audio corresponding to the target icon, such as causing the target icon to appear along with the audio stuck point or the accent point, thereby enhancing the information expression effect.

Step c, obtaining a recommended display mode of the target icon based on the recommended display position, the recommended display animation and the recommended display time. In addition, the size of the target icon may be intelligently matched based on the video image information, that is, the recommended display mode may include other display information such as the recommended display size, and there is no limitation here.

For convenience of understanding, referring to a schematic diagram of a generation flow of a recommended display mode shown in FIG. 3, it is schematically illustrated that audio input data, video input data, and text input data can affect the target icon and its display mode, the content of the text input may be obtained based on the subtitle input by the user, or may be obtained by performing speech recognition on audio or video and converting it to text. For the subtitle “After a whole day's work, she enjoys a relaxing walk in the park under the golden sun”, one or more text feature processes such as text token, word class tagging, word class reduction, spelling correction, text feature analysis, word frequency analysis, etc. can be carried out, keyword detection and icon matching based on the processing results can be performed, and a plurality of word-icon matching pairs can be obtained, the icons are candidate icons. Specifically, the candidate icons corresponding to the target subtitle include: briefcase icon corresponding to “work”, walking icon corresponding to “walk”, tree icon corresponding to “park”, and sun icon corresponding to “sun”. Then, each candidate icon is scored based on the scoring dimension described above, and the first two candidate icons with the highest score are selected as target icons based on the number of selected target icons (taking 2 as an example). In addition, the display mode of the target icon can be recommended in combination with data such as video input and text input, and the display mode of the target icon can be comprehensively determined in combination with setting parameters of the target icon such as icon size and icon style input by the user. Through the above method, the target icon and the display mode of the target icon conforming to the current input information of text subtitle, audio and video can be reasonably and reliably obtained, the display mode includes but is not limited to the display size, display position, display animation and display time of the target icon, etc. The information expression ability and video appeal can be better enhanced by displaying the target icon. It should be noted that FIG. 3 is merely an exemplary illustration and should not be regarded as a limitation. In practical applications, more or less analysis processing may be performed for the target barrage, such as for Chinese, word form reduction is not required.

In some embodiments, the step of generating the target video based on the first video and the recommended display mode of the target icon can be executed with reference to the following steps 1 to 3.

Step 1, obtaining second reference information; the second reference information including at least one selected from a group consisting of size information of the target icon, appearance timing information of the target icon, and animation style information of the target icon.

For example, the setting control of the second reference information may be provided for the user, and the second reference information set by the user may be obtained based on the setting control, so as to meet the needs of the user. For example, the user can set the size of the target icon by providing a slide control, the user can select the animation style of the target icon by providing a resource card control for presenting the animation style of the icon, and the user can set the appearance timing of the target icon by providing an option control of the appearance timing of the icon such as a page/sentence/word icon, so as to determine whether the target icon appears with video image, with a corresponding target subtitle, or with a corresponding word in the target subtitle.

Step 2, determining a target display mode of the target icon based on the second reference information and the recommended display mode of the target icon. It can be understood that the recommended display mode of the target icon may be obtained by analyzing the target subtitle and video image information corresponding to the target subtitle by the background algorithm, and the second reference information may be obtained by user setting. In some embodiments, the target display mode is the union of the second reference information and the recommended display mode of the target icon, and when there is conflict information in the second reference information and the recommended display mode of the target icon, the second reference information prevails, in other words, the user setting takes priority. For example, in response to the animation style indicated by the second reference information being different from the recommended animation style of the target icon, the animation style indicated by the second reference information is adopted. In some embodiments, the preview video may be presented to the user according to the recommended display mode of the target icon, and control for setting the second reference information may be provided to the user, and in the case where the second reference information set by the user through the control is obtained, the target icon and the corresponding display mode may be adjusted based on the second reference information, thereby obtaining the target display mode.

Step 3: generating a target video based on the first video and the target display mode. Exemplarily, rendering the target icon on the video image of the first video can be performed based on target display mode to generate a target video based on the video image after rendering.

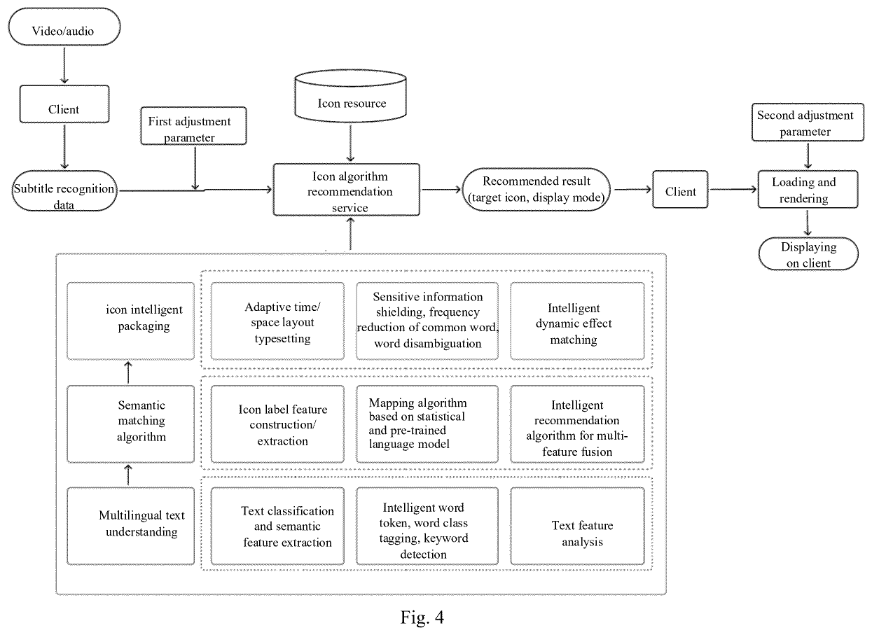

On the basis of the foregoing, the embodiment of the present disclosure further provides a schematic diagram illustrating a video generation flow as shown in FIG. 4, which shows that a user can upload audio and video to server through client for processing, a server can perform subtitle recognition, and on the basis of a first adjustment parameter, generate an icon recommendation result corresponding to subtitle recognition data by using an icon algorithm recommendation service, and return it to the client, and the client can determine the target display mode of a target icon in combination with the second adjustment parameter, thereby loading and rendering the video image added with the target icon and displaying it on the client. For example, FIG. 4 symbolically illustrates the processing module mainly adopted by the icon algorithm recommendation service. First, the multilingual text understanding module can perform text feature processing, such as text classification and semantic feature extraction, intelligent token, word class tagging, keyword detection, text feature analysis, etc., and then the semantic matching algorithm module can perform processing based on the output result of the multilingual text understanding module. In a specific implementation, the semantic matching algorithm module can construct and extract the icon label feature, and can also map the icon and the word token result by using the language model, and the mapping algorithm can be realized based on the intelligent recommendation algorithm of multi-feature fusion, and finally the target icon can be determined, and the recommended display mode of the target icon can be further determined by the icon intelligent packaging module. It should be noted that FIG. 4 is only an example, and in practical applications, functional modules may be divided in other ways, each functional module may include more or fewer units, and the units included in different functional modules may also be adjusted. Units such as sensitive information shielding, frequency reduction of common words, and word disambiguation units may also be classified as multilingual text understanding module or semantic matching module, and are not limited herein. In addition, both the first adjustment parameter and the second adjustment parameter in FIG. 4 may be user-set parameters. For example, the first adjustment parameter may directly affect the icon algorithm recommendation service, and the second adjustment parameter may be used to make changes to the recommendation result. For example, the first adjustment parameter may be a number constraint of the target icon, a repetition constraint of the target icon, or the like, and the second adjustment parameter may be a size, an appearance timing, an animation style, or the like of the target icon, and may be flexibly set in detail, and is not limited here.

In summary, the video processing method provided by the embodiment of the present disclosure can parse the subtitle, adaptively add an appropriate target icon in combination with at least one of video image information or audio information associated with the subtitle, further improve information expression capabilities through the icon on the basis of the subtitle, and also increase video interesting and video appeal, so as to better improve the user's video viewing experience.

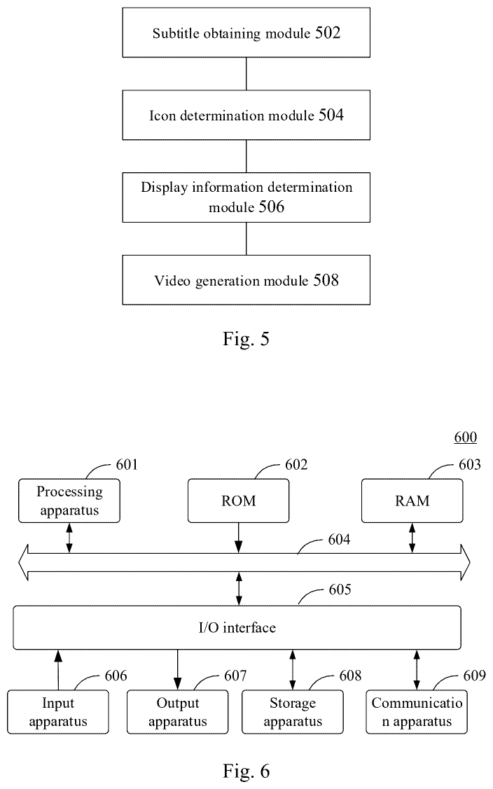

Corresponding to the aforementioned video processing method, an embodiment of the present disclosure further provides a video processing apparatus. FIG. 5 is a schematic structural diagram of a video processing apparatus provided by the embodiment of the present disclosure. The apparatus can be implemented by software and/or hardware, and can generally be integrated into an electronic device. As shown in FIG. 5, the video processing apparatus includes:
a subtitle obtaining module 502, configured to obtain a target subtitle corresponding to a first video;
an icon determination module 504, configured to perform text parsing on a target subtitle, and determine a target icon corresponding to the target subtitle based on a text parsing result of the target subtitle;
a display information determination module 506 configured to obtain video associated information corresponding to the target subtitle in the first video, and determine a recommended display mode of the target icon based on the video associated information, the video associated information including at least one of video image information or audio information;
a video generation module 508, configured to generate a target video based on the first video and the recommended display mode of the target icon, the target video being a video in which the target subtitle and the target icon are displayed on a video image of the first video.

The apparatus can perform parsing on the subtitle, adaptively add appropriate target icon in combination with at least one of video image information or audio information associated with the subtitle, further improve the information expression ability through the icon on the basis of the subtitle, and also increase the interest and appeal of the video, so as to better improve the user's video viewing experience.

In some embodiments, the text parsing result of the target subtitle includes a token result of the target subtitle and target information corresponding to the token result, and the target information includes at least one selected from a group consisting of a word position, a word class, a word occurrence frequency, and an associated word. The determining a target icon corresponding to the target subtitle based on a text parsing result of the target subtitle includes: determining a candidate icon corresponding to the target subtitle based on a token result of the target subtitle; and determining a target icon corresponding to the target subtitle from the candidate icon based on target information corresponding to the token result.

In some embodiments, the determining a candidate icon corresponding to the target subtitle based on the token result of the target subtitle includes: determining, using a semantic matching model, an icon having a mapping relationship with a target word in the target subtitle based on the token result of the target subtitle and a preset icon resource library; and determining the candidate icon corresponding to the target subtitle based on the icon corresponding to the target word.

In some embodiments, the determining a target icon corresponding to the target subtitle from the candidate icon based on the target information corresponding to the token result includes: obtaining first reference information, the first reference information including at least one selected from a group consisting of: accent information of audio corresponding to the target subtitle, feature analysis information of the target subtitle, or number constraint information of the target icon; and determining the target icon corresponding to the target subtitle from the candidate icon based on the first reference information and the target information corresponding to the token result.

In some embodiments, the obtaining video associated information corresponding to the target subtitle in the first video includes: obtaining motion information and target object information of the video image corresponding to the target subtitle in the first video, and obtaining the video image information corresponding to the target subtitle based on the motion information and the target object information; and/or, obtaining key point information of audio corresponding to the target subtitle in the first video, and obtaining the audio information corresponding to the target subtitle based on the key point information.

In some embodiments, the determining a recommended display mode of the target icon based on the video associated information includes: determining a recommended display position and a recommended display animation of the target icon based on the video image information; determining a recommended display time for the target icon based on the audio information; and obtaining the recommended display mode of the target icon based on the recommended display position, the recommended display animation, and the recommended display time.

In some embodiments, the generating a target video based on the first video and the recommended display mode of the target icon includes: obtaining second reference information, the second reference information including at least one selected from a group consisting of: size information of the target icon, occurrence timing information of the target icon, or animation style information of the target icon; determining a target display mode of the target icon based on the second reference information and the recommended display mode of the target icon; and generating a target video based on the first video and the target display mode.

The video processing apparatus provided by the embodiment of the present disclosure can execute the video processing method provided by any embodiment of the present disclosure, and has functional modules and beneficial effects corresponding to the video processing method.

Those skilled in the art can clearly understand that, for convenience and conciseness of the description, the specific working process of the apparatus embodiment described above may refer to the corresponding process in the method embodiment, and will not be repeated here.

An embodiment of the present disclosure provides an electronic device, the electronic device includes: a storage apparatus on which a computer program is stored; a processing apparatus configured to execute the computer program in the storage apparatus to implement the steps of any one of the methods of the present disclosure.

Referring to of FIG. 6 below shows a schematic structural diagram of an electronic device 600 suitable for implementing embodiments of the present disclosure. The terminal device in the embodiment of the present disclosure may include, but is not limited to, a mobile terminal such as a mobile phone, a notebook computer, a digital broadcast receiver, a personal digital assistant (PDA), a Tablet PC (PAD), a portable multimedia player (PMP), an vehicle-mounted terminal (for example, an in-mounted navigation terminal), and the like, and a fixed terminal such as a digital TV, a desktop computer, and the like. The electronic device illustrated in FIG. 6 is merely an example, and should not impose any limitation on the functionality and scope of use of the embodiments of the present disclosure.

As shown in FIG. 6, the electronic device 600 may include a processing apparatus (e.g., central processing unit, graphics processing unit, etc.) 601 that may perform various appropriate actions and processes according to a program stored in the read-only memory (ROM) 602 or a program loaded from the storage apparatus 608 into the random access memory (RAM) 603. In the RAM 603, various programs and data necessary for the operation of the electronic device 600 are also stored. The processing apparatus 601, the ROM 602, and the RAM 603 are connected to each other by a bus line 604. An input/output (I/O) interface 605 is also connected to the bus line 604.

Generally, the following apparatuses may be connected to the I/O interface 605: an input apparatus 606 including, for example, touchscreen, touchpad, keyboard, mouse, camera, microphone, accelerometer, gyroscope, etc.; an output apparatus 607 including, for example, a liquid crystal display (LCD), a speaker, a vibrator, and the like; a storage apparatus 608 including, for example, magnetic tape, hard disk, etc.; and a communication apparatus 609. The communication apparatus 609 may allow the electronic device 600 to communicate wirelessly or wired with other devices to exchange data. While FIG. 6 shows an electronic device 600 with various devices, it should be understood that it is not required that all of the apparatuses shown be implemented or provided. More or fewer apparatuses may alternatively be implemented or provided.

In particular, according to an embodiment of the present disclosure, the process described above with reference to the flowchart may be implemented as a computer software program. For example, an embodiment of the present disclosure includes a computer program product, which includes a computer program carried on a non-transitory computer-readable medium, the computer program includes program code for performing the method shown in the flowchart. In such an embodiment, the computer program may be downloaded and installed from a network through the communication apparatus 609, installed from the storage apparatus 608, or installed from the ROM 602. When the computer program is executed by the processing apparatus 601, the above-mentioned functions defined in the method of the embodiment of the present disclosure are performed.

In addition to the methods and apparatus described above, embodiments of the present disclosure may further provide computer program product including computer program instructions that, when executed by the computer program, cause the processor to perform the methods provided by the embodiments of the present disclosure. The computer program product may write program code for performing the operations of the embodiments of the present disclosure in any combination of one or more programming languages, including object-oriented programming languages such as Java, C++, and the like, as well as conventional procedural programming languages such as the “C” language or similar programming languages. The program code may execute entirely on the user computing device, partially on the user device, as an independent software package, partially on the user computing device and partially on a remote computing device, or entirely on a remote computing device or server.

In addition, embodiments of the present disclosure may further provide a computer-readable storage medium having a computer program instructions stored thereon, and the computer program instructions, when executed by the processor, causes the processor to execute the video processing method provided by the embodiment of the present disclosure.

The computer-readable storage medium can adopt any combination of one or more readable mediums. The readable medium may be a readable signal medium or a readable storage medium. The readable storage medium may be, for example but not limited to, electric, magnetic, optical, electromagnetic, infrared, or semiconductor systems, apparatuses, or devices, or any combination thereof. More specific examples (non-exhaustive list) of the readable storage medium may include, but are not limited to: an electrical connection having one or more wires, a portable disk, a hard disk, a random access memory (RAM), a read-only memory (ROM), an erasable programmable read-only memory (EPROM or a flash memory), an optical fiber, a portable compact disc read-only memory (CD-ROM), an optical storage device, a magnetic storage device, or any suitable combination thereof.

Embodiments of the present disclosure further provide a computer program product including a computer program/instruction, and the computer program/instructions, when executed by a processor, implement the video processing method in the embodiment of the present disclosure.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

It should be noted that, herein, relational terms such as “first” and “second” are used merely to distinguish one entity or operation from another entity or operation, and do not necessarily require or imply any such actual relationship or order between the entities or operations. Moreover, the terms “comprising,” “including,” or any other variation thereof are intended to encompass a non-exclusive inclusion such that a process, method, article, or apparatus that includes a series of elements includes not only those elements, but also other elements that are not explicitly listed, or elements inherent to such a process, method, article, or apparatus. Without further limitation, an element defined by the statement “including a” does not preclude the presence of additional identical element in a process, method, article, or apparatus including the element.

The foregoing is merely a specific embodiment of the present disclosure to enable those skilled in the art to understand or implement the present disclosure. Various modifications to these embodiments will be obvious to those skilled in the art, and the general principles defined herein may be implemented in other embodiments without departing from the spirit or scope of the present disclosure. Accordingly, the present disclosure is not to be limited to the embodiments described herein, but is to be accorded the widest scope consistent with the principles and novel features disclosed herein.

1. A video processing method, comprising:
obtaining a target subtitle corresponding to a first video;
performing text parsing on the target subtitle, and determining a target icon corresponding to the target subtitle based on a text parsing result of the target subtitle;
obtaining video associated information corresponding to the target subtitle in the first video, and determining a recommended display mode of the target icon based on the video associated information, wherein the video associated information comprises at least one of video image information or audio information; and
generating a target video based on the first video and the recommended display mode of the target icon, wherein the target video is a video in which the target subtitle and the target icon are displayed on a video image of the first video.

2. The method according to claim 1, wherein the text parsing result of the target subtitle comprises a token result of the target subtitle and target information corresponding to the token result, and the target information comprises at least one selected from a group consisting of a word position, a word class, a word occurrence frequency, and an associated word;
the determining a target icon corresponding to the target subtitle based on a text parsing result of the target subtitle comprises:
determining a candidate icon corresponding to the target subtitle based on the token result of the target subtitle; and
determining a target icon corresponding to the target subtitle from the candidate icon based on the target information corresponding to the token result.

3. The method according to claim 2, wherein the determining a candidate icon corresponding to the target subtitle based on the token result of the target subtitle comprises:
determining, using a semantic matching model, an icon having a mapping relationship with a target word in the target subtitle based on the token result of the target subtitle and a preset icon resource library; and
determining the candidate icon corresponding to the target subtitle based on the icon corresponding to the target word.

4. The method according to claim 2, wherein the determining a target icon corresponding to the target subtitle from the candidate icon based on the target information corresponding to the token result comprises:
obtaining first reference information, the first reference information comprising at least one selected from a group consisting of: accent information of audio corresponding to the target subtitle, feature analysis information of the target subtitle, or number constraint information of the target icon; and
determining the target icon corresponding to the target subtitle from the candidate icon based on the first reference information and the target information corresponding to the token result.

5. The method according to claim 1, wherein the obtaining video associated information corresponding to the target subtitle in the first video comprises:
obtaining motion information and target object information of the video image corresponding to the target subtitle in the first video, and obtaining the video image information corresponding to the target subtitle based on the motion information and the target object information; and/or,
obtaining key point information of audio corresponding to the target subtitle in the first video, and obtaining the audio information corresponding to the target subtitle based on the key point information.

6. The method according to claim 1, wherein the determining a recommended display mode of the target icon based on the video associated information comprises:
determining a recommended display position and a recommended display animation of the target icon based on the video image information;
determining a recommended display time for the target icon based on the audio information; and
obtaining the recommended display mode of the target icon based on the recommended display position, the recommended display animation, and the recommended display time.

7. The method according to claim 1, wherein the generating a target video based on the first video and the recommended display mode of the target icon comprises:
obtaining second reference information, the second reference information comprising at least one selected from a group consisting of: size information of the target icon, occurrence timing information of the target icon, or animation style information of the target icon;
determining a target display mode of the target icon based on the second reference information and the recommended display mode of the target icon; and
generating a target video based on the first video and the target display mode.

8. An electronic device, comprising:
a storage apparatus, stored with a computer program; and
a processing apparatus, configured to execute the computer program in the storage apparatus to implement a video processing method,
wherein the video processing method comprises:
obtaining a target subtitle corresponding to a first video;
performing text parsing on the target subtitle, and determining a target icon corresponding to the target subtitle based on a text parsing result of the target subtitle;
obtaining video associated information corresponding to the target subtitle in the first video, and determining a recommended display mode of the target icon based on the video associated information, wherein the video associated information comprises at least one of video image information or audio information; and
generating a target video based on the first video and the recommended display mode of the target icon, wherein the target video is a video in which the target subtitle and the target icon are displayed on a video image of the first video.

9. The electronic device according to claim 8, wherein the text parsing result of the target subtitle comprises a token result of the target subtitle and target information corresponding to the token result, and the target information comprises at least one selected from a group consisting of a word position, a word class, a word occurrence frequency, and an associated word;
the determining a target icon corresponding to the target subtitle based on a text parsing result of the target subtitle comprises:
determining a candidate icon corresponding to the target subtitle based on the token result of the target subtitle;
determining a target icon corresponding to the target subtitle from the candidate icon based on the target information corresponding to the token result.

10. The electronic device according to claim 9, wherein the determining a candidate icon corresponding to the target subtitle based on the token result of the target subtitle comprises:
determining, using a semantic matching model, an icon having a mapping relationship with a target word in the target subtitle based on the token result of the target subtitle and a preset icon resource library; and
determining the candidate icon corresponding to the target subtitle based on the icon corresponding to the target word.

11. The electronic device according to claim 9, wherein the determining a target icon corresponding to the target subtitle from the candidate icon based on the target information corresponding to the token result comprises:
obtaining first reference information, the first reference information comprising at least one selected from a group consisting of: accent information of audio corresponding to the target subtitle, feature analysis information of the target subtitle, or number constraint information of the target icon; and
determining the target icon corresponding to the target subtitle from the candidate icon based on the first reference information and the target information corresponding to the token result.

12. The electronic device according to claim 8, wherein the obtaining video associated information corresponding to the target subtitle in the first video comprises:
obtaining motion information and target object information of the video image corresponding to the target subtitle in the first video, and obtaining the video image information corresponding to the target subtitle based on the motion information and the target object information; and/or,
obtaining key point information of audio corresponding to the target subtitle in the first video, and obtaining the audio information corresponding to the target subtitle based on the key point information.

13. The electronic device according to claim 8, wherein the determining a recommended display mode of the target icon based on the video associated information comprises:
determining a recommended display position and a recommended display animation of the target icon based on the video image information;
determining a recommended display time for the target icon based on the audio information; and
obtaining the recommended display mode of the target icon based on the recommended display position, the recommended display animation, and the recommended display time.

14. The method according to claim 8, wherein the generating a target video based on the first video and the recommended display mode of the target icon comprises:
obtaining second reference information, the second reference information comprising at least one selected from a group consisting of: size information of the target icon, occurrence timing information of the target icon, or animation style information of the target icon;
determining a target display mode of the target icon based on the second reference information and the recommended display mode of the target icon; and
generating a target video based on the first video and the target display mode.

15. A non-transitory computer-readable storage medium, wherein the non-transitory computer-readable storage medium stores a computer program for performing a video processing method,
wherein the video processing method comprises:
obtaining a target subtitle corresponding to a first video;
performing text parsing on the target subtitle, and determining a target icon corresponding to the target subtitle based on a text parsing result of the target subtitle;
obtaining video associated information corresponding to the target subtitle in the first video, and determining a recommended display mode of the target icon based on the video associated information, wherein the video associated information comprises at least one of video image information or audio information; and
generating a target video based on the first video and the recommended display mode of the target icon, wherein the target video is a video in which the target subtitle and the target icon are displayed on a video image of the first video.

16. The non-transitory computer-readable storage medium according to claim 15, wherein the text parsing result of the target subtitle comprises a token result of the target subtitle and target information corresponding to the token result, and the target information comprises at least one selected from a group consisting of a word position, a word class, a word occurrence frequency, and an associated word;
the determining a target icon corresponding to the target subtitle based on a text parsing result of the target subtitle comprises:
determining a candidate icon corresponding to the target subtitle based on the token result of the target subtitle;
determining a target icon corresponding to the target subtitle from the candidate icon based on the target information corresponding to the token result.

17. The non-transitory computer-readable storage medium according to claim 15, wherein the determining a candidate icon corresponding to the target subtitle based on the token result of the target subtitle comprises:
determining, using a semantic matching model, an icon having a mapping relationship with a target word in the target subtitle based on the token result of the target subtitle and a preset icon resource library; and
determining the candidate icon corresponding to the target subtitle based on the icon corresponding to the target word.

18. The non-transitory computer-readable storage medium according to claim 15, wherein the determining a target icon corresponding to the target subtitle from the candidate icon based on the target information corresponding to the token result comprises:
obtaining first reference information, the first reference information comprising at least one selected from a group consisting of: accent information of audio corresponding to the target subtitle, feature analysis information of the target subtitle, or number constraint information of the target icon; and
determining the target icon corresponding to the target subtitle from the candidate icon based on the first reference information and the target information corresponding to the token result.

19. The non-transitory computer-readable storage medium according to claim 15, wherein the obtaining video associated information corresponding to the target subtitle in the first video comprises:
obtaining motion information and target object information of the video image corresponding to the target subtitle in the first video, and obtaining the video image information corresponding to the target subtitle based on the motion information and the target object information; and/or,
obtaining key point information of audio corresponding to the target subtitle in the first video, and obtaining the audio information corresponding to the target subtitle based on the key point information.

20. The non-transitory computer-readable storage medium according to claim 15, wherein the determining a recommended display mode of the target icon based on the video associated information comprises:
determining a recommended display position and a recommended display animation of the target icon based on the video image information;
determining a recommended display time for the target icon based on the audio information; and
obtaining the recommended display mode of the target icon based on the recommended display position, the recommended display animation, and the recommended display time.
